(19) United States
(12) Patent Application Publication
(10) Pub. No.: US 2014/0033075 A1
(43) Pub. Date: Jan. 30, 2014

(54) Managing User Endorsements in Online Social Networking Systems

(71) Applicant: OFFERPOP CORPORATION, New York, NY (US)

(72) Inventors: Wendell Lansford, New York, NY (US); Prakash Mishra, Stamford, CT (US)

(73) Assignee: OFFERPOP CORPORATION, New York, NY (US)

(21) Appl. No.: 13/950,821

(22) Filed: Jul. 25, 2013

Related U.S. Application Data
(60) Provisional application No. 61/675,424, filed on Jul. 25, 2012.

(51) Int. Cl. H04L 29/06

(52) U.S. Cl. CPC H04L 65/403
USPC 715/753

(57) ABSTRACT

A computer system facilitates the process of enabling users of an online social networking system to endorse online content. A user of the online social networking system provides input representing an address (e.g., URL) of the content. In response, the system generates code implementing a mechanism for endorsing the content (such as a Facebook “like” button) and provides the code as output to the user. The user may then insert the code into a page (e.g., a Facebook page or a web page external to Facebook) containing the content, thereby producing a modified page. The modified page may be rendered to display a Facebook “like” button or other means for endorsing the content. Furthermore, the user may use the system to control the appearance of messages (such as Facebook news feed stories) that are generated in response to an endorsement of the content, and to track content endorsements.

### CROSS REFERENCE TO RELATED APPLICATIONS

This application claims priority from U.S. Prov. Pat. App. Ser. No. 61/675,424, filed on Jul. 25, 2012, entitled, “Managing User Endorsements in Online Social Networking Systems,” which is hereby incorporated by reference herein.

This application is related to U.S. patent application Ser. No. 13/856,602, filed on Apr. 4, 2013, entitled, “Shared Link Tracking in Online Social Networking Systems,” which is hereby incorporated by reference herein.

### BACKGROUND

One of the primary goals of Facebook and other social networking systems is to facilitate the sharing of a wide variety of content among users in a wide variety of ways. One of the original reasons that users began using social networking systems was that they provided a convenient, user-friendly, easy way to engage in such content sharing, without requiring users to have knowledge of HTML or web programming, and without requiring users to visit different sites or use different mechanisms to share different kinds of content with other users. As a result, users of online social networking systems today often use such systems to share information about their interests and activities with other users.

One sharing mechanism that the Facebook social networking system provides to each registered user of the system is a personal page, known as a “wall,” which displays a variety of information related to that user, such as personal information about the user, content posted by the user, and content posted by other users within the user's network on Facebook. A user's Facebook wall, therefore, serves as a single, easily accessible, repository of information about that user, including both information provided by that user and information provided about that user by other users of Facebook.

One particular sharing-related feature of Facebook that has become particularly popular is the “like” button feature. Using this feature, it is possible for a Facebook user to put a “like” button on that user's Facebook page or on a non-Facebook web page. If another user (the “liking user”) clicks on such a “like” button, Facebook generates a story in the Facebook news feeds of the liking user's Facebook friends (i.e., the users who are in the liking user's network on Facebook). This story indicates that the liking user likes the content that appears on the same page as the “like” button that was clicked. For example, if a user named “John Smith” clicks on a “like” button that appears on the web page for the movie “The Hunger Games,” then Facebook may generate a story which says that “John Smith likes the Hunger Games”. Such a story may contain a hyperlink back to the web page for the movie “The Hunger Games.” Furthermore, the movie “The Hunger Games” will be displayed in the “Likes and Interests” section of the liking user's Facebook profile. Facebook “like” buttons are often used by companies and other organizations in connection with those organizations in connection with products and services provided by those organizations.

Facebook also provides each Facebook user who owns a page that contains a “like” button with the ability to target advertising to users who have clicked on that “like” button. For example, the owner of the web site for “The Hunger Games” may push advertisements to all Facebook users who have clicked on the “like” button on the web site for “The Hunger Games.”

These and other features of the Facebook “like” button provide a variety of benefits to owners of “like” buttons, to users who click on “like” buttons, and to other users of Facebook. For example, a content owner that associates a “like” button with its content obtains a mechanism for enabling users to promote such content to other users by clicking on the “like” button. Such an endorsement of content (and related products and/or services) from a particular user to that user's friends may carry more weight than a traditional advertisement originating from the content owner, and may therefore be more likely to encourage the user's friends to purchase products and/or services associated with the endorsed content. Another benefit to content owners is that associating “like” buttons with content is less expensive than many traditional forms of marketing, such as advertising in magazines or on television, and is more likely to lead to content going “viral” than such traditional forms of marketing.

From the perspective of users who click on “like” buttons, such buttons provide a mechanism for doing something that such users likely would have done in the absence of like buttons—sharing their likes and interests with their friends—but more effectively and with less effort. More specifically, Facebook “like” buttons enable users to inform all of their Facebook friends that they like particular content with a single click, without taking additional steps such as composing an email message or specifying the recipients of such a message. Furthermore, as described above, clicking on a “like” button causes the liking user's friends to receive a story that informs them that the liking user has liked particular content and that provides a hyperlink back to the liked content. Because the story containing the identity of the liking user, a summary of the liked content, and a hyperlink back to the liked content, is generated automatically by Facebook, the “like” button mechanism enables users to share their likes with their friends in a form that is concise, informative, and useful (because such friends may click on the hyperlink to view the liked content if they are interested in exploring it further).

The Facebook “like” button feature is also useful to users who are friends of users who click on “like” buttons because Facebook automatically provides such users with information about the content that their friends like. Any user of Facebook may simply log into his or her Facebook account and see, in the user's profile page, stories that indicate which content has been liked by that user's friends. The user may then explore such content simply by clicking on the stories. The Facebook “like” mechanism thereby provides Facebook users with an easy way to find out about and explore content that their friends like with a minimum of effort.

One problem with Facebook's “like” button feature, however, is that providing a “like” button within a Facebook page or other web page can be tedious and time-consuming. In particular, inserting a “like” button into a page requires the creation and insertion of particular code conforming to the Open Graph Protocol. Customizing the appearance of a like button and functionality provided by the like button requires customization of such code. Although Facebook provides tools for simplifying the customization of certain aspects of such code, Facebook users who lack the requisite technical skill to write and modify such code might find it difficult or impossible to customize such code in the ways necessary to meet their requirements.

What is needed, therefore, are improved techniques for enabling users to endorse content in online social networks.

### SUMMARY

A computer system facilitates the process of enabling users of an online social networking system to endorse online content. A user of the online social networking system provides input representing an address (e.g., URL) of the content. In response, the system generates code implementing a mechanism for endorsing the content (such as a Facebook “like” button) and provides the code as output to the user. The user may then insert the code into a page (e.g., a Facebook page or a web page external to Facebook) containing the content, thereby producing a modified page. The modified page may be rendered to display a Facebook “like” button or other means for endorsing the content. Furthermore, the user may use the system to control the appearance of messages (such as Facebook news feed stories) that are generated in response to an endorsement of the content, and to track content endorsements.

### BRIEF DESCRIPTION OF THE DRAWINGS

FIG. 1A is a dataflow diagram of a system for enabling a user of an online social networking system to generate endorsement code that may be used by other users of the online social networking system to endorse online content according to one embodiment of the present invention;

FIG. 1B is a dataflow diagram of a system for modifying content in an online social networking system with endorsement code to make content endorsable according to one embodiment of the present invention;

FIG. 1C is a dataflow diagram of a system for using endorsement code to generate endorsements of content according to one embodiment of the present invention;

FIG. 1D is a dataflow diagram of a system for providing messages in response to endorsement of online content according to one embodiment of the present invention;

FIG. 2A is a flowchart of a method performed by the system of FIG. 1A according to one embodiment of the present invention;

FIG. 2B is a flowchart of a method performed by the dataflow diagram of FIG. 1C according to one embodiment of the present invention; and

FIGS. 3A-3C are illustrations of user interfaces implemented according to various embodiments of the present invention.

### DETAILED DESCRIPTION

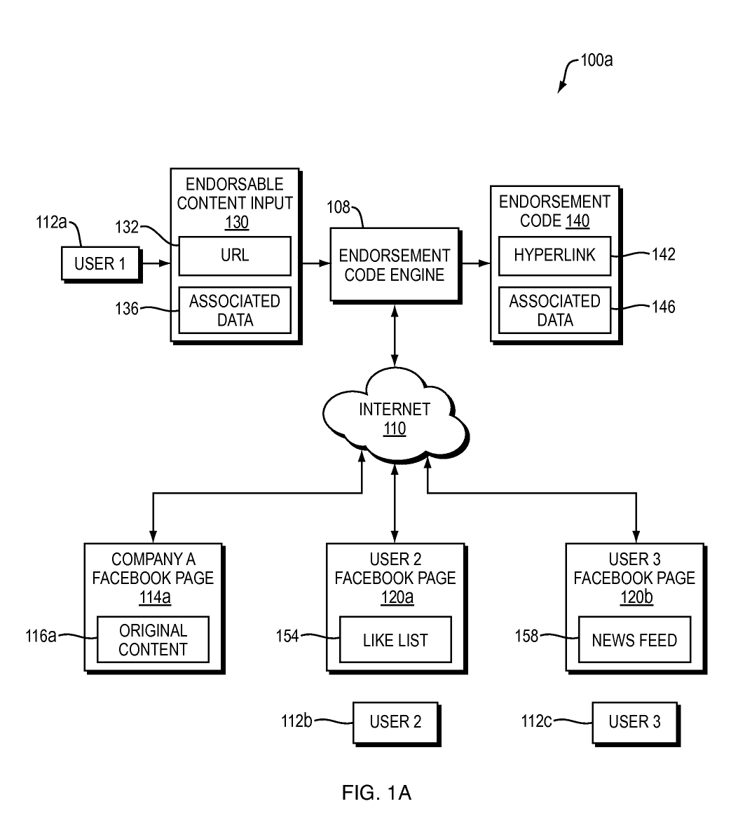

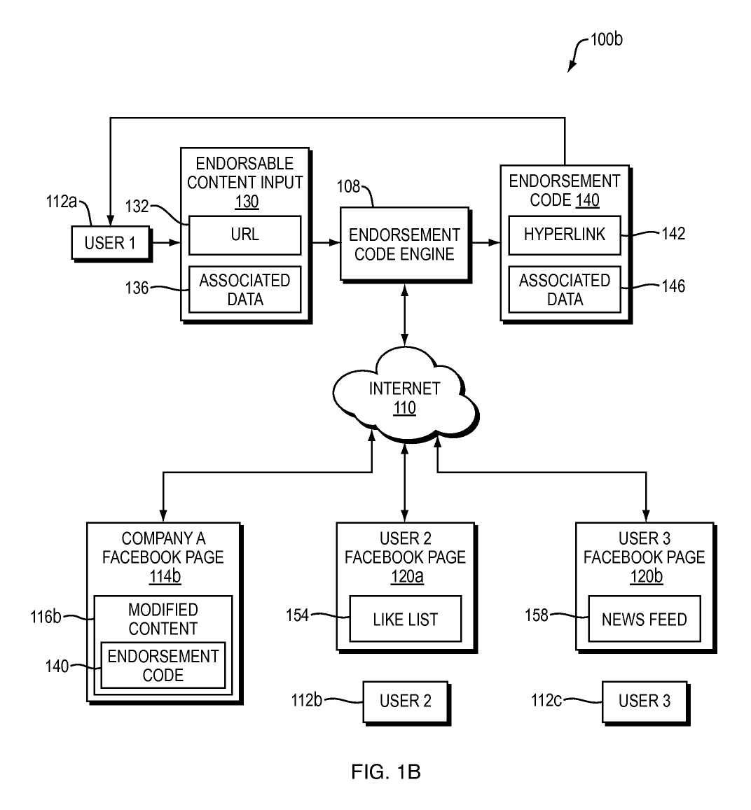

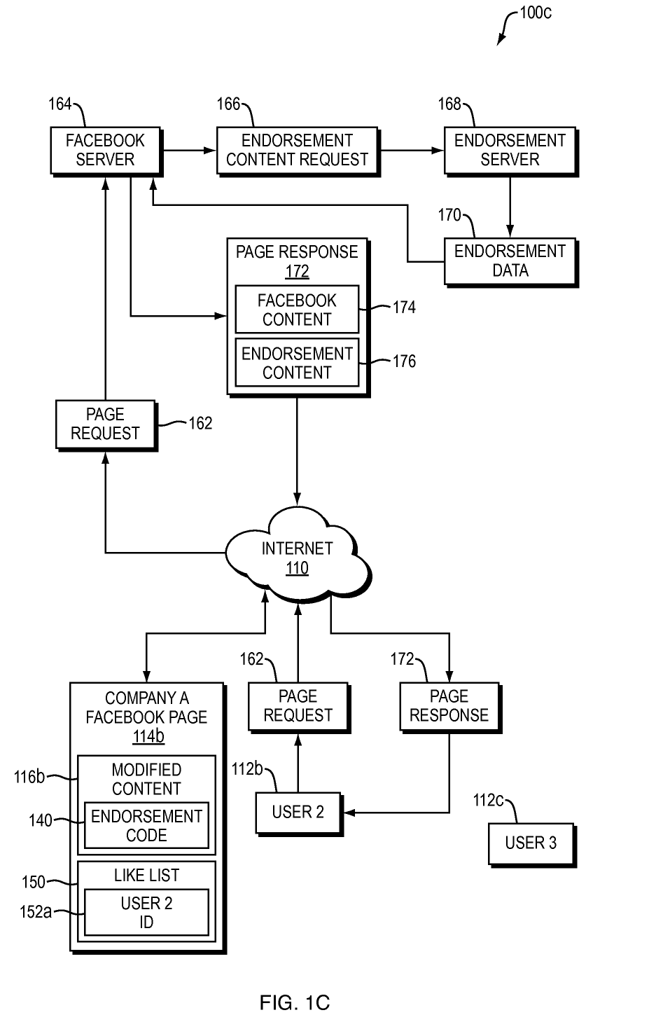

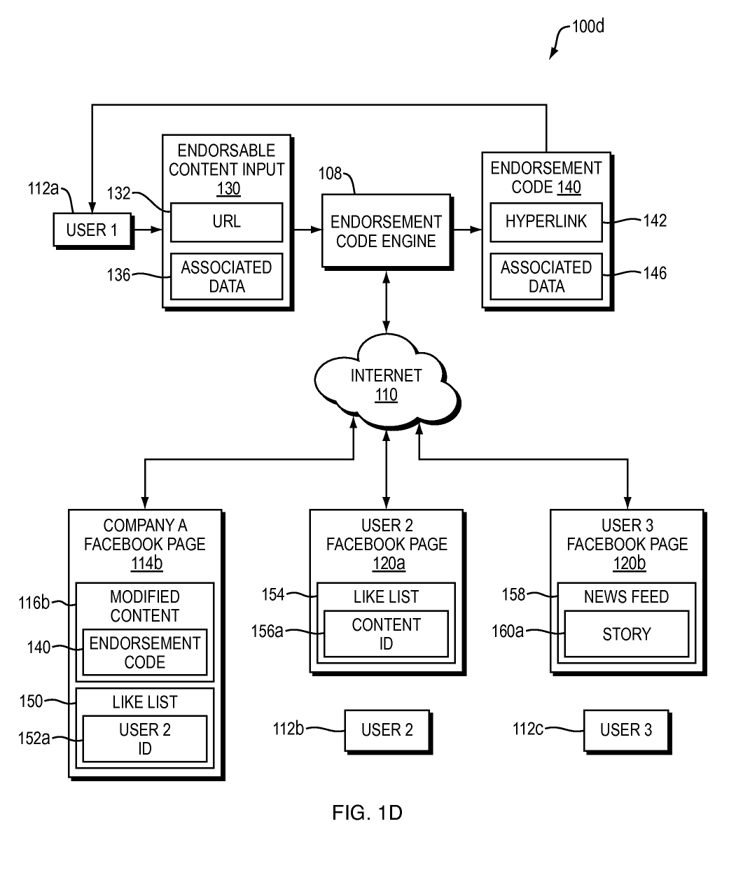

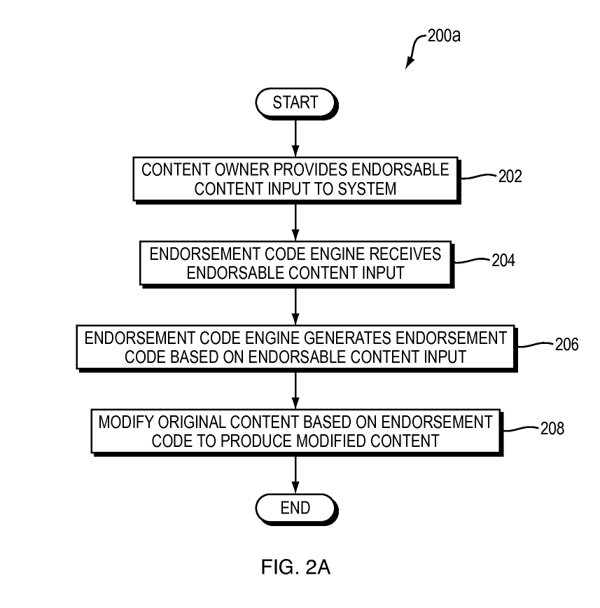

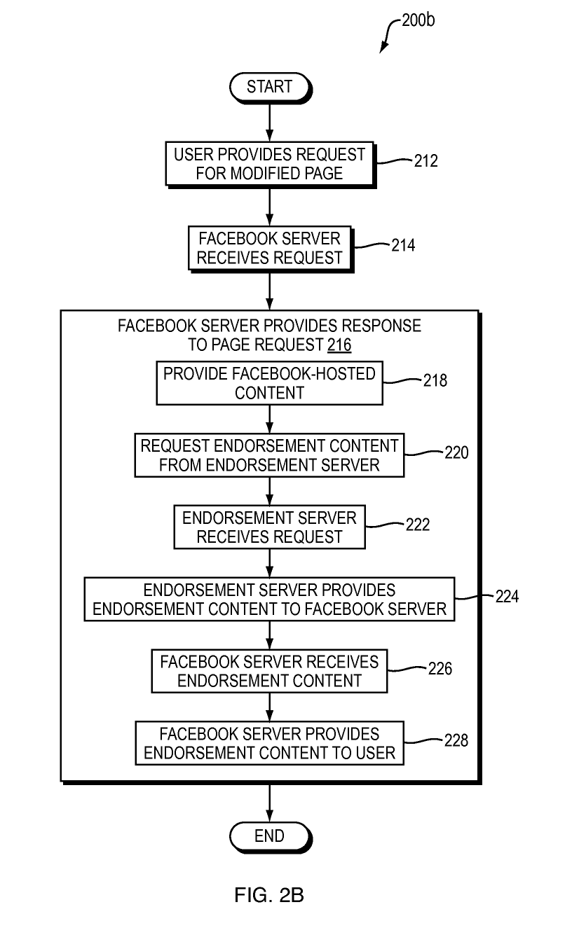

A computer system facilitates the process of enabling users of an online social networking system to endorse online content. For example, referring to FIG. 1A, a dataflow diagram is shown of a system 100a for enabling a user 112a of an online social networking system, such as Facebook, to generate endorsement code 140 that may be used by other users 112b-c of the online social networking system to endorse online content according to one embodiment of the present invention. Referring to FIG. 2A, a flowchart is shown of a method 200a that is performed by the system 100a of FIG. 1A according to one embodiment of the present invention.

Assume, for example, that user 112a wishes to enable other users (such as users 112b-c) to endorse content owned, hosted, managed, or otherwise controlled by the user 112a. For ease of explanation, the user 112a will be referred to as the “owner” of the content to be made endorsable. The user 112a may provide endorsable content input 130 to the system 100a (FIG. 2A, operations 202 and 204). In general, the endorsable content input 130 contains data representing content which the user 112a desires to make endorsable by other users of the system 100a. For example, the endorsable content input 130 may include an address (such as a Uniform Resource Locator (URL) 132) and/or other identifier of content that the user 112a wishes to make endorsable. An example of “endorsable” content is content that can be “liked” on Facebook by clicking a “like” button that is associated with the content. Clicking on such a “like” button is an example of endorsing the content associated with the “like” button.

Examples of content that may be made endorsable include content contained within an online social network (such as content contained within Facebook of Twitter) and content contained within a web page, even if that web page is external to Facebook. For example, the Open Graph Protocol may be used to associate a Facebook “like” button within content in a web page that is external to Facebook. More generally, any content that may be associated with a Facebook “like” button or that may be associated with a mechanism for endorsing the content within an online social networking system is content that is “endorsable” as that term is used herein. For example, Twitter enables users to specify that particular content on Twitter is a “favorite” of the user. Clicking on a “favorite” button or otherwise providing input indicating that content on Twitter is a “favorite” is an example of endorsing that content.

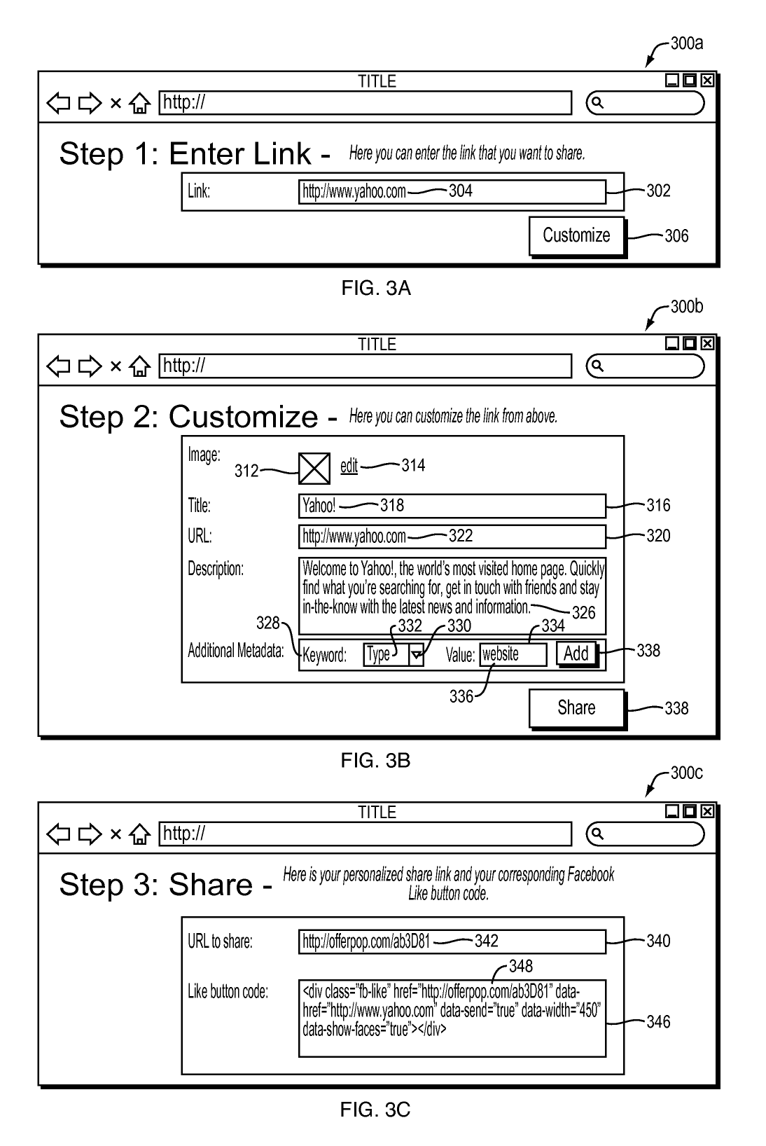

The user 112a may provide the endorsable content input 130 in any of a variety of ways. For example, referring to FIG. 3A, an illustration is shown of an example of a user interface 300a that may be used by the system 100a to solicit and receive the endorsable content input 130 from the user 112a. The user interface 300a includes a text box 302 into which the user 112a may type, paste, or otherwise input text 304 representing the URL 132 of the content that the user 112a wishes to make endorsable. FIG. 3A shows an example in which the user 112a has input the text 304 “http://www.yahoo.com” as the URL 132. The particular user interface 300a shown in FIG. 3A is merely an example and does not constitute a limitation of the present invention.

Returning to the example of FIG. 1A, a company (referred to herein as “Company A”) is associated with a Facebook page 114a, which contains original content 116a. As the explanation above implies, although the Facebook page 114a may be a page within Facebook or another online social networking system, alternatively the page 114a may be a web page that is not contained within Facebook or any other online social networking system. As is well-known to those having ordinary skill in the art, a Facebook page, such as Facebook page 114a, may be accessible to the user 112a and to other users of the same online social networking system over the Internet 110 and/or other networks. The Facebook page 114a may, for example, be served by a Facebook server (not shown) in response to requests made by the user 112a and other users to view contents of the Facebook page 114a. The user 112a may, for example, use a conventional web browser or a special-purpose application to send such requests to the Facebook server and to render the Facebook page 114a on a suitable computing device in response to receipt of some or all of the Facebook page 114a (or data derived from the Facebook page 114a) by such a computing device.

Furthermore, although only one Facebook page 114a is shown in FIG. 1A for ease of illustration, the system 100a may include any number of Facebook pages, which may be associated with one or more companies. Furthermore, Facebook is used merely as an example of an online social networking system in FIG. 1A. More generally, a company may be associated with any number of online social networks (e.g., zero, one, two, or more). Similarly, although the Facebook page 114a in FIG. 1A is shown as containing only one unit of content 116a, the page 114a may contain any number of units of content.

Furthermore, although element 114a is labeled as a “page” in FIG. 1A, this is merely an example and does not constitute a limitation of the present invention. As another example, element 114a may be a subset of a Facebook page. As yet another example, element 114a may be any form of content contained within Facebook or another online social networking system. For ease of explanation, however, element 114a will be described herein as a “Facebook page.”

Although the Facebook page 114a is illustrated in FIG. 1A as being owned by, created by, maintained by, or otherwise associated with a “company,” this is merely an example and does not constitute a limitation of the present invention. More generally, the Facebook page 114a may be owned by, created by, maintained by, or otherwise associated with any user or set of users of an online social networking system, including users who are individuals rather than companies or other organizations. Therefore, any reference herein to a “company” should be understood to refer more generally to any entity, such as a for-profit or non-profit organization, or an individual person.

Now assume, for purposes of example, that the endorsable content input 130 specifies the original content 116a. For example, the URL 132 may be a URL of the original content 116a or of the page 114a more generally. In general, the system 100a may generate endorsement code 140 for making the content specified by the endorsable content input 130 (e.g., the original content 116a) endorsable.

More specifically, the system 100a includes an endorsement code engine 108. The endorsement code engine 108 receives the endorsable content input 130 (FIG. 2A, operation 204) and generates endorsement code 140 based on the endorsable content input 130 (FIG. 2A, operation 206). The endorsement code 140 may be any code or other data that may be used to make the content specified by the endorsable content input 130 (e.g., the original content 116a) endorsable. For example, the endorsement code 140 may include HTML code, such as HTML code defined according to the Open Graph Protocol, that defines a Facebook “like” button. The endorsement code 140 may, for example, be such that the endorsement code 140 may be inserted within the page (e.g., page 114a) that contains the content specified by the endorsable content input 130 (e.g., the original content 116a), thereby making such content endorsable. More generally, the endorsement code 140 may be associated with the content specified by the endorsable content input 130 to make such content endorsable, whether or not the endorsement code 140 is inserted within the same page as such content.

Embodiments of the present invention enable the user 112a who creates the endorsement code 140 to customize the appearance of the endorsement code 140 when that code is rendered in connection with the endorsable content 116a. For example, the user 112a may provide not only the URL 132 of the content 116a to be made endorsable, but also additional data 136 that is to be associated with the endorsable content 116a. The user 112a may, for example, provide such associated data 136 within the endorsable content input 130 in operation 202 of FIG. 2A. The endorsement code engine 108 may therefore receive the associated data 136 in operation 204 of FIG. 2A.

The associated data 136 may include any data that the user 112a desires to be associated with the modified content 116b when the modified content 116b is rendered to users. For example, the associated data 136 may include any one or more of the following: one or more images, one or more videos, one or more text strings, and one or more advertisements.

The user 112a may provide the associated data 136 in any of a variety of ways. For example, referring to FIG. 3B, an illustration is shown of an example of a user interface 300b that may be used by the system 100a to solicit and receive the associated data 136 from the user 112a. The system 100a may display the user interface 300b to the user 112a automatically after the user 112a has provided the URL 304 in the text box 302 of FIG. 2A, or the system 100a may display the user interface 300b to the user 112a only if, and in response to, the user 112a selecting a “Customize” button 306 or otherwise providing input indicating that the user 112a wishes to provide input representing the associated data 136.

The user interface 300b includes a mechanism for enabling the user 112a to provide input that selects one or more images to associate with the endorsable content 116a. For example, the user interface 300b includes a checkbox 312 which the user 112a may select to indicate that the user 112a wishes to specify one or more images to be associated with the endorsable content 116a. If the user 112a provides input to select checkbox 312, then the user 112a may also click on an edit link 314, in response to which the system 100a may display a file dialog box (not shown) or other mechanism for enabling the user 112a to provide input that selects one or more image files to associate with the endorsable content 116a. If the user 112a leaves checkbox 312 unchecked, then the user 112a may not specify any image to associate with the endorsable content 116a, in which case a default image (such as an image selected by Facebook from the Facebook page 114a) or no image may be associated with the endorsable content 116a.

The user interface 300b also includes a text box 316 into which the user 112a may input text 318 that represents a title of the endorsable content 116a. In the example illustrated in FIG. 3B, the user 112a has typed or otherwise input the text “Yahoo!” 318 into the text box 316. As a result, the system 100a will associate the title “Yahoo!” with the endorsable content 116a. If the user 112a leaves text box 316 empty, then a default title (such as a title selected by Facebook from the Facebook page 114a) may be associated with the endorsable content 116a.

The user interface 300b also includes a text box 320 for containing the URL 132 of the endorsable content 116a. The system 100a may initially copy the text 304 from box 302 (FIG. 3A) into the text 322 of box 320 (FIG. 3B) to eliminate the need for the user 112a to provide the URL 132 twice. The user 112a may, however, edit the text 322 to modify the URL 132 if desired.

The user interface 300b also includes a text box 324 into which the user 112a may input text 326 that represents a description of the endorsable content 116a. In the example illustrated in FIG. 3B, the user 112a has typed or otherwise input the following text 326 into box 324: “Welcome to Yahoo!, the world's most visited home page. Quickly find what you're searching for, get in touch with friends and stay in-the-know with the latest news and information.” As a result, the system 100a will associate the description 326 with the endorsable content 116a. If the user 112a leaves text box 324 empty, then a default description (such as a description selected by Facebook from the Facebook page 114a) may be associated with the endorsable content 116a.

The user interface 300b also includes an additional metadata section 328 via which the user 112a may provide input that specifies one or more additional units of metadata to associate with the endorsable content 116a. In particular, the additional metadata section 328 includes a keyword dropdown list 330, a value text field 334, and an add button 338. In general, the user 112a may use the additional metadata section 328 to associate, with the endorsable content 116a, one or more units of additional metadata, each of which includes both a keyword and a value. For example, to associate an additional unit of metadata with the endorsable content 116a, the user 112a may select a keyword from the keyword dropdown list 330 (such as the keyword “Type” 332 in FIG. 3B), type or otherwise input a value into the value text field 334 (such as the value “website” in FIG. 3B), and then click the “Add” button 338. In response, the system 100a may associate the specified keyword and value with the endorsable content 116a. The user 112a may repeat these steps to associate any number of additional units of metadata with the endorsable content 116a.

Upon providing all desired input via the user interface 300b, the user 112a may click a “Share” button 338, in response to which the system 100a may generate the endorsement code 140 (FIG. 2A, operation 206). The system 100a may also associate the endorsement code 140 with the endorsable content 116a, such as by inserting the endorsement code 140 within the endorsable content 116a to produce the modified content 116b.

The various inputs that the user 112a may provide via the user interface 300b of FIG. 3B (such as input provided via any of the user interface elements 312, 314, 316, 320, 324, and 328) are examples of associated data 136 (FIGS. 1A and 1B) that the user 112a may provide as input to the system 100. When the endorsement code engine 108 generates the endorsement code 140 based on the endorsable content input 130, the endorsement code engine 108 may include, within the endorsement code 140, associated data 146. The associated data 146 may be any data generated based on the associated data 136 provided by the sharing user 112a. For example, the associated data 146 may be a copy of the associated data 136 provided by the sharing user 112a, or may be data that differs from the associated data 136 provided by the sharing user 112a but nevertheless generated based on the associated data 136.

For example, if the sharing user 112a specified, via the associated data 136, the desire to associate the modified content 116b with a particular image from the page 114a that contains the original content 116a, then the associated data 146 may contain the particular image and/or an identifier of the particular image. As another example, if the sharing user 112a specified, via the associated data 136, a text string representing a summary of the original content 116a, then the associated data 146 may contain the text string or an identifier of the text string.

Therefore, in general, the associated data 146 may contain any data that may be used to render the content specified by the associated data 136 when the modified Facebook page 114a is rendered to users. Examples of particular techniques that may be used to generate the associated data 146 and to render the associated data are described in the above-referenced patent application entitled, “Shared Link Tracking in Online Social Networking Systems.”

Referring to FIG. 1B, a dataflow diagram of a system 100b for modifying the Facebook page 114a with the endorsement code 140 to make the original content 116a endorsable according to one embodiment of the present invention is shown. The system 100b may include some or all of the elements of the system 100a of FIG. 1A, even though all of the elements of the system 100a may not be shown in FIG. 1B for ease of illustration. Therefore, any reference herein to the system 100a of FIG. 1A should be understood to be equally applicable to the system 100b of FIG. 1B, and vice versa. More generally, the reference number 100 may be used herein to refer generally to either of both of systems 100a (FIG. 1A) and 100b (FIG. 1B).

The endorsement code 140 may be used in a variety of ways to modify the original content 116a and/or the Facebook page 114a more generally to make the original content 116a endorsable. For example, some or all of the endorsement code 140 (or data derived from the endorsement code 140) may be inserted into the original content 116a to produce modified content 116b within modified Facebook page 114b, as shown in FIG. 1B. For example, if the endorsement code 140 consists of or contains HTML code, and the original content 116a consists of or contains HTML code, then the endorsement code 140 may be inserted within the HTML code of the original content 116a to produce modified HTML code in the modified content 116b.

Alternatively, for example, some or all of the endorsement code 140 (or data derived from the endorsement code 140) may be inserted into the Facebook page 114a, but outside of the original content 116a, to produce modified Facebook page 114b, thereby making the original content 116a endorsable from within modified Facebook page 114b.

As the examples above illustrate, the entire endorsement code 140, a portion of the endorsement code 140, and/or data derived from the endorsement code 140 may be inserted into the Facebook page 114a or the original content 116a to produce the modified content 116b (FIG. 2A, operation 208). Therefore any reference herein to inserting “the endorsement code 140” into the original content 116a should be understood to refer to inserting any of the foregoing into the Facebook page 114a and/or the original content 116a.

The endorsement code 140 may be inserted into the original content 116a in any of a variety of ways. For example, the endorsement code engine 108, or other component of the system 100, may automatically insert the endorsement code 140 into the original content 116a to produce the modified content 116b.

As another example, the endorsement code engine 108 may provide the endorsement code 140 to the user 112a or another user. Such a user may manually insert the endorsement code 140 into the original content 116a to produce the modified content 116b. For example, referring to FIG. 3C, an illustration is shown of an example of a user interface 300c that may be used by the system 100c to generate and/or display the endorsement code 140 to the user 112a. The system 100b may, for example, display the user interface 300c to the user 112a automatically after the user 112a selects the “Share” button 338 in FIG. 3B.

The user interface 300c includes a text box 340 for displaying a URL 342 that the user 112a may share with other users to enable those users to view the modified content 116b. More specifically, as illustrated by the example of FIG. 3C, the URL 342 may differ in various ways from the original URL 322 (FIG. 3B) of the original content 116a. For example, the top-level domain (e.g., “offerpop.com”) of the shared URL 342 may differ from the top-level domain (e.g., “yahoo.com”) of the original URL 322. Furthermore, the shared URL 342 may include a path (e.g., “ab3D81”) that differs from the path, if any, of the original URL 322. Various ways in which the shared URL 342 may be used will be described in more detail below.

The user interface 300c also includes a text box 346 for displaying a textual representation 348 of the endorsement code 140. In the example of FIG. 3C, the endorsement code 348 takes the form of an HTML “<div>” element, which includes the shared URL 342, the original URL 322, and various parameters defined according to the Open Graph Protocol. The use of an HTML “<div>” element to implement the endorsement code 140, however, is merely an example and does not constitute a limitation of the present invention.

Once the system 100b has displayed the endorsement code 348 to the user 112a, the user 112a may copy and paste the endorsement code 348 from the user interface 300c into the original content 116a, thereby creating the modified content 116b.

Regardless of how the endorsement code 140 is inserted into the original content 116a to produce the modified content 116b, once the endorsement code 140 has been so inserted, the endorsement code 140 may be used to generate endorsements of the modified content 116b in a variety of ways.

For example, referring to FIG. 1C, a dataflow diagram is shown of a system 100c for using the endorsement code 140 to generate endorsements of the modified content 116b according to one embodiment of the present invention. Referring to FIG. 2B, a flowchart is shown of a method 200b that is performed by the system 100c of FIG. 1C according to one embodiment of the present invention.

Recall that in the example of FIGS. 1A-1B, the user 112a used the endorsement code engine 108 to create the endorsement code 140 and to create the modified content 116b by inserting the endorsement code 140 into the original content 116a. Now assume, for purposes of example, that another user of the system 100c, such as user 112b, navigates to the modified content 116b, such as by navigating to the Facebook page 114b that contains the modified content 116b. The user 112b may, for example, provide a request 162 to a web browser for the Facebook page 114b, such as by clicking on a link to the Facebook page 114b (FIG. 2B, operation 212).

A Facebook server 164 receives the request 162 (FIG. 2B, operation 214). In response to the request 162 for the modified Facebook page 114b, the Facebook server 164 transmits a page response 172 to the user 112b (FIG. 2B, operation 216). In general, the page response 172 contains data sufficient for enabling the user 112b's web browser to render the modified Facebook page 114b, including any content resulting from executing the endorsement code 140.

More specifically, for example, in response to receiving the request 162, the Facebook server 164 may provide, within the page response 172, any content 174 within the modified Facebook page 114b that is hosted by Facebook (FIG. 2B, operation 218). The user 112b's web browser may receive such Facebook content 174 and render it within a rendering of the Facebook page 114b.

When the Facebook server 164 encounters the endorsement code 140 within the Facebook page 114b, the Facebook server 164 may execute the code 140 by, for example, identifying the shared URL 342 within the endorsement code 140 and transmitting a request 166 for endorsement content to an endorsement server 168 located at the identified URL 342 (FIG. 2B, operation 220). The request 166 may include, for example, any parameters contained within the endorsement code 140. Note that the endorsement server 168 may be a server that is not a Facebook server. For example, the endorsement server 168 may be addressable via a top-level domain that differs from the top-level domain Facebook server 164.

The endorsement server 168 receives the request 166 (FIG. 2B, operation 222) and responds to it by providing endorsement content 170 to the Facebook server 164 (FIG. 2B, operation 224). The endorsement content 170 may, for example, include data representing any of the data 146 associated with the endorsed content 116b, such as any image, title, description, and/or other metadata specified by the user 112a through the user interface 300b of FIG. 3B.

The Facebook server 164 receives the endorsement content 170 (FIG. 2B, operation 226). The Facebook server 164 then provides the endorsement content 170 to the user 112b as part of the page response 172 (FIG. 2B, operation 228). User 112b's web browser may then use the page response 172 to render the Facebook page 114b, thereby producing a rendering of the Facebook page 114b (not shown). Such a rendering may include, for example, a rendering of the Facebook content 174 and a rendering of the endorsement content 176, which may include, for example, a mechanism (such as a Facebook “like” button) via which the user 112b may endorse the modified content 116b, and renderings of any of the data 146 associated with the modified content 116b, such as renderings of the image, title, description, and/or additional metadata specified by the user 112a via the user interface 300b.

The user 112b who is viewing the rendering of the page 114b may endorse the modified content 116b, such as by clicking on the “like” button or otherwise selecting or activating the user interface element that was rendered based on the endorsement code 140. Assume, for example, that user 112a owns the Facebook page 114b and that user 112a therefore used the system 100a of FIG. 1A to generate the endorsement code 140 and used the system 100b of FIG. 1B to insert the endorsement code 140 into the Facebook page 114b. Further assume that user 112b endorses the modified content 116b in any of the ways described above. Further assume that user 112b and user 112c are in each other's network within a particular online social networking system (e.g., that user 112b and 112c are “friends” within the Facebook online social networking system).

The endorsement server 168 may obtain, store, track, and analyze any of a variety of information related to the endorsing user (e.g., the user 112b), such as any one or more of the following: the content endorsed by the request 166, the endorsing user's unique identifier (e.g., Facebook ID) within the social networking system associated with the server 164, email address, telephone number, mailing address, real name, or any combination thereof. The endorsement server 168 may obtain such information from any of a variety of sources, such as the endorsement content request 166 and/or the page request 162. The endorsement server 168 may track any such information for any of the endorsable content disclosed herein, such as an entire web page or a portion thereof. Furthermore, the endorsement server 168 may track any such information for endorsable content hosted by the social networking system in which the endorsable content is endorsed (e.g., Facebook) and for endorsable content that is hosted outside such a social networking system (e.g., on a web page outside of Facebook). As an example, the endorsement server 168 may track, for each of one or more users of a social networking system, both: (1) endorsements enabled by the social networking system of content associated with the user, where the content is hosted within the social networking system (e.g., on a page within Facebook), and (2) endorsements enabled by the social networking of content associated with the user, where the content is hosted outside the social networking system (e.g., on a web page external to Facebook).

As a result of user 112b endorsing the modified content 116b, the system 100 may take any of a variety of actions, as illustrated by the dataflow diagram of the system 100c of FIG. 1D. For example, a “like” list 150 may be associated with the modified content 116b or with the modified page 114b more generally. In general, the like list 150 identifies the user or users who have endorsed the modified content 116b. Although the like list 150 is shown in FIG. 1C as being contained within the page 114b, this is merely an example. Alternatively, for example, the like list 150 may be stored externally to the page 114b but be associated with the page 114b or the modified content 116b.

Therefore, in response to the user 112b endorsing the modified content 116b, the system 100c may add an identifier 152a of the user 112b to the like list 150 associated with modified content 116b, thereby storing a record indicating that the user 112b has endorsed the modified content 116b. When the page 114b (including the modified content 116b) is rendered to the user 112b or to other users, information about the user 112b (such as the Facebook ID of the user 112b) may be rendered, thereby identifying the user 112b as a user who has endorsed the modified content 116b.

As another example, the user 112b may have his or her own Facebook page 120a. User 112b's Facebook page 120a may contain a “like” list 154 which identifies the content (if any) which the user 112b has endorsed. In response to the user 112b endorsing the modified content 116b, the system 100c may add an identifier 156a of the user 112b to the like list 154 associated with the user 112b, thereby storing a record indicating that the user 112b has endorsed the modified content 116b. When user 112b's Facebook page 120a is rendered to the user 112b or to other users, some or all of user 112b's like list 154 may be rendered. For example, the content ID 156a may be used to render information about the modified content 116b, such as by rendering any one or more of the following: an image associated with the modified content 116b, a summary of the modified content 116b, and a URL of the modified content (e.g., URL 132). In this way, other users within user 112b's online social network may be informed of the content that has been endorsed by user 112b.

As another example, user 112c may have his or her own Facebook page 120b. Recall that user 112c is in the online social network of user 112b. User 112c's Facebook page 120b may contain a news feed 158 which contains units of content referred to herein as “stories,” but which may be any kinds of units of content. In response to the user 112b endorsing the modified content 116b, the system 100c may add a story 160a to the news feed 158 of the user 112c. The story 160a may indicate that user 112b has endorsed the modified content 116b. When user 112c's Facebook page 120b is rendered to the user 112c or to other users, some or all of user 112c's news feed 158 may be rendered. For example, the story 160a may be used to render information about the endorsement of the modified content 116b by the user 112b, such as by rendering any one or more of the following: content identifying the endorsing user 112b (such as text stating that user 112b has endorsed the modified content 116b), an image associated with the modified content 116b, a summary of the modified content 116b, and a URL of the modified content (e.g., URL 132). In this way, user 112c, and other users within user 112b's online social network, may be informed that user 112b has endorsed the modified content 116b.

Embodiments of the present invention may also be used to track which user(s) have endorsed (e.g., “liked”) a particular piece of content in an online social networking system, such as Facebook. As described above, a user may click on a “like” button that was generated based on the endorsement code 140 and thereby endorse the associated content 116b. Facebook is capable of storing a record of the identity of the user who clicked on the “like” button, because users are required to log in to Facebook before clicking on a “like” button. As a result, Facebook can store information about which content a particular user has “liked.” This enables Facebook to display information about which content users have liked, such as in the like list 150, the like list 154, and the news feed 158 of FIG. 1D.

Embodiments of the present invention may leverage this ability by enabling content owners (e.g., the owner of the Facebook page 114b) to transmit messages (e.g., advertisements, such as in the form of Facebook wall posts and sponsored stories) to users who have endorsed (e.g., “liked”) the owners' content. More specifically, for any particular piece of endorsable content, the owner of the content may transmit a message to all users who have endorsed (e.g., “liked”) that particular piece of endorsable content. This is true whether the endorsable content is an entire page or any portion thereof (such as an image, text, or a hyperlink). This is also true whether the endorsable content is hosted by the social networking system in which the endorsable content is endorsed (e.g., Facebook) or whether the endorsable content is hosted outside such a social networking system (e.g., on a web page outside of Facebook). As a result, embodiments of the present invention enable messages (e.g., advertisements) to be targeted to users who have endorsed content located outside of the social network in which the endorsed content is endorsed.

Embodiments of the present invention have a variety of advantages. For example, embodiments of the present invention enable content owners to customize the appearance of Facebook “like” buttons and other content endorsement mechanisms easily and without needing to write code directly. Instead, users of embodiments of the present invention may use a user-friendly interface to specify how a “like” button will appear. The user merely needs to provide information about the title, description, and image to be associated with the “like” button. In response, embodiments of the present invention provide the user with both code that may be used to implement the “like” button and a link that the user may share with others to the content associated with the “like” button. In addition to making it easy to create “like” buttons, such embodiments enable users to customize “like” buttons in ways that are not provided by Facebook out of the box.

Furthermore, endorsing content (such as by clicking on a “like” button associated with the content) may cause a message or other content to be created (such as a Facebook wall post or news feed story). Embodiments of the present invention enable the appearance of such an “endorsement message” to be customized by the owner of the endorsed content. This provides a benefit over the default behavior of Facebook, according to which the appearance of the endorsement message is chosen by Facebook and is not customizable by the content owner. Because endorsement messages (such as Facebook's “sponsored stories”) are a primary mechanism by which products, services, and other forms of content are marketed on Facebook and other online social messages, the ability to customize the appearance of such messages provides content owners with the ability to hone their marketing messages to users of online social networks.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The description herein refers to certain online social networking systems, such as Facebook and Twitter, merely for purposes of example. Embodiments of the present invention are not limited to use in conjunction with these particular online social networking systems, but instead may be used in conjunction with any one or more online social networking systems. More generally, embodiments of the present invention may be used in conjunction with any online system for hosting content, such as any web site. Therefore, any reference herein to an “online social networking system” should be understood to refer more generally to any online system for hosting content, whether or not such a system includes social networking features.

Any “content” disclosed herein, such as content 116aa and content 116ab, may be any kind of content. For example, such content may be or include any one or more of the following in any combination: text, image, audio, video, hyperlinks, web pages or any portion thereof, messages (such as email messages, text messages, or any kind of message transmissible from one user to another user within an online social networking system), wall posts, and any kind of content that may be posted on or otherwise hosted by an online social networking system.

Any reference herein to a “product” should be understood to refer to a product and/or a service. Similarly, any reference herein to a “service” should be understood to refer to a product and/or a service.

Certain concepts described herein may be known by other names. For example, a “wall” on Facebook or other social networking system may also be referred to as a “timeline.” As another example, a “wall post” on Facebook or other social networking system may also be referred to as a “story.”Therefore any reference to a “wall,” “wall post,” or other concept that is also known by other names should be understood to refer to the concept generally, regardless of the name by which it is referred.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor executing computer program instructions stored in at least one non-transitory computer-readable medium, the method comprising:
(A) receiving a request from a first user to make content endorsable, comprising:
(A)(1) receiving an address of the content from the first user;
(A)(2) receiving data associated with the content from the first user;
(B) providing a means for endorsing the first content, comprising:
(B)(1) rendering the data associated with the content;
(C) receiving, from the second input via the means for endorsing the first content, a request from a second user to endorse the first content; and
(D) storing a record of the second user's endorsement of the first content.

2. The method of claim 1, further comprising:
(E) receiving, from the first user, endorsement message customization data; and
(F) in response to receiving the request from the second user to endorse the first content, generating an endorsement message based on the endorsement message customization data.

3. The method of claim 2, further comprising:
(G) transmitting the endorsement message to the first user.

4. The method of claim 2, further comprising:
(G) transmitting the endorsement message to the second user.

5. The method of claim 2, further comprising:
(G) transmitting the endorsement message to a third user.

6. A non-transitory computer-readable medium comprising computer program instructions executable by at least one computer processor to perform a method, the method comprising:
(A) receiving a request from a first user to make content endorsable, comprising:
(A)(1) receiving an address of the content from the first user;
(A)(2) receiving data associated with the content from the first user;
(B) providing a means for endorsing the first content, comprising:
(B)(1) rendering the data associated with the content;
(C) receiving, from the second input via the means for endorsing the first content, a request from a second user to endorse the first content; and
(D) storing a record of the second user's endorsement of the first content.

7. The non-transitory computer-readable medium of claim 6, wherein the method further comprises:
(E) receiving, from the first user, endorsement message customization data; and
(F) in response to receiving the request from the second user to endorse the first content, generating an endorsement message based on the endorsement message customization data.

8. The non-transitory computer-readable medium of claim 7, wherein the method further comprises:
(G) transmitting the endorsement message to the first user.

9. The non-transitory computer-readable medium of claim 7, wherein the method further comprises:
(G) transmitting the endorsement message to the second user.

10. The non-transitory computer-readable medium of claim 7, wherein the method further comprises:
(G) transmitting the endorsement message to a third user.
